(19) United States
(12) Patent Application Publication
(10) Pub. No.: US 2007/0195786 A1
(43) Pub. Date: Aug. 23, 2007

(54) Packet data scheduling method

(75) Inventors: Jun Cheng, Kyoto (JP); Akihiko Nishio, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 10/593,309

(22) PCT Filed: Mar. 4, 2005
(86) PCT No.: PCT/JP05/03790

§ 371 Date: Sep. 18, 2006

(30) Foreign Application Priority Data
Mar. 22, 2004 (JP) 2004-082891

(51) Int. Cl. H04L 12/56

(52) U.S. Cl. 370/395.4

(57) ABSTRACT

There is provided a scheduling method for scheduling packet data capable of improving channel use efficiency while maintaining both of QoS and fairness of each mobile station (each flow). The scheduling method includes ST (step) 10 for setting a total transmission set value C (initial value), ST20 for calculating a traffic amount Sk of each mobile station (each flow) by using the GPS, ST30 for allocating a packet of each mobile station (each flow) to each sub channel, ST40 for calculating an actual transmission ratio C′, ST50 for judging whether the number of remaining sub channels to which no packet has been allocated in ST30 is equal to or below a threshold value, ST60 for calculating the transmission ratio Delta C of the remaining sub channels if the number of the remaining sub channels is greater than the threshold value, and ST70 for resetting C=C′+Delta C.

### TECHNICAL FIELD

The present invention relates to a packet data scheduling method.

### BACKGROUND ART

In a mobile communication system, studies have been carried out on efficient scheduling methods which satisfy QoS (Quality of Service) required for applications, determine transmission priority for packets and the traffic amount in consideration of, for example, changes in a propagation path and an interference state, and assign wireless resources accordingly. Among them, application of the GPS (Generalized Processor Sharing) scheduling method (hereinafter abbreviated to “GPS method”) performing scheduling of transmission packets in consideration of both fairness between mobile stations and QoS, to a mobile communication system has been studied (for example, see Non-Patent Document 1)

In this GPS method, by assigning weight to mobile stations (flows) in accordance with a total transmission rate setting value and determining an available transmission traffic amount per mobile station (instantaneous transmission rate), it is possible to secure fairness in assigning wireless resources between mobile stations. In the GPS method, on the assumption that the total transmission rate is constant, scheduling is performed by determining a total transmission rate setting value. In other words, in the conventional GPS method, a total transmission rate setting value is set in accordance with a constant total transmission rate known in advance.
Non-Patent Document 1: L. Xu, X. Shen, and J. Mark, “Dynamic bandwidth allocation with fair scheduling for WCDMA systems,” IEEE Wireless Communications, pp. 26-32, April 2002

### DISCLOSURE OF INVENTION

### Problems to be Solved by the Invention

However, in a mobile communication system where packets are simultaneously transmitted to a plurality of mobile stations in a wireless environment, since the transmission rate of a subchannel differs for every mobile station using that subchannel, the total transmission rate of the channel changes in accordance with the result of subchannel assignment to the mobile stations. The “subchannel” here is equivalent to, for example, a subcarrier in-multicarrier communication such as OFDM (Orthogonal Frequency Division Multiplexing), and a spreading code that is subjected to multicode-multiplex in CDMA (Code Division Multiple Access) communication.

For example, upon assignment of subcarriers to mobile stations, in OFDM, in the Max-C/I method whereby subcarriers are assigned, per subcarrier, to the mobile stations having the best channel quality, the following is observed. That is, if the CQI's (Channel Quality Indicator) of mobile stations at a certain point are as shown in FIG. 1, subcarriers 1, 2 and 4 are assigned to mobile station 1, and subcarrier 3 is assigned to mobile station 2, and, therefore, the total transmission rate here is 14 bits/s. Here, assume that channel quality is better as the value of CQI increases, and CQI=1, CQI=2, CQI=3, and CQI=4 correspond to the modulation schemes of BPSK (1 bit), QPSK (2 bits), 8PSK (3 bits) and 16QAM (4 bits), respectively. Also, if the CQI's of mobile stations at a certain point are as shown in FIG. 2, subcarriers 3 and 4 are assigned to mobile station 1 and subcarriers 1 and 2 are assigned to mobile station 2, and, therefore, the total transmission rate changes to 12 bits/s. Thus, in a mobile communication system, the total transmission rate of a channel changes in accordance with the result of subchannel assignment to mobile stations.

In the case where the total transmission rate changes as above, there is a problem of a total transmission rate setting value in the GPS method. For example, when the total transmission rate setting value is set at 6000 bits/s, the weighting factor for mobile station 1 is ⅘ and the weighting factor for mobile station 2 is ⅕, to maintain both fairness and QoS for mobile stations 1 and 2, it is necessary to maintain the instantaneous transmission rate for mobile station 1 at 4800 bits/s and the instantaneous transmission rate for mobile station 2 at 1200 bits/s at all times. Here, if the present actual total transmission rate is 4000 bits/s, the present actual total transmission rate (4000 bits/s) is less than the total transmission rate setting value (6000 bits/s), and, therefore, it is difficult to maintain both fairness and QoS for mobile stations 1 and 2. In other words, if assignment of subchannels is determined by giving priority to the QoS of one of mobile station 1 or mobile station 2, the QoS of the other station fails and furthermore fairness is lost.

In contrast, a method of estimating and setting a total transmission rate setting value to be less than a predicted actual total transmission rate may be possible. For example, a case is considered where the total transmission rate setting value is set at 2000 bits/s when the actual total transmission rate is 4000 bits/s. Similar to above, when the weighting factor for mobile station 1 is ⅘ and the weighting factor for mobile station 2 is ⅕, to maintain both fairness and QoS for mobile stations 1 and 2, it is necessary to maintain the instantaneous transmission rate for mobile station 1 at 1600 bits/s and the instantaneous transmission rate for mobile station 2 at 400 bits/s at all times. In this case, the actual total transmission rate (4000 bits/s) is greater than the total transmission rate setting value (2000 bits/s), so that it is possible to satisfy both fairness and QoS for mobile stations 1 and 2. However, there is waste of 2000 bits/s (the actual total transmission rate 4000 bits—the total transmission rate setting value 2000 bits/s) of channel resources, and consequently channel use efficiency is reduced. Hence, in the GPS method, when the total transmission rate setting value is estimated to be less than the actual total transmission rate and set, it is possible to maintain both fairness between mobile stations and QoS. However, channel use efficiency is reduced, and, as a result, throughput is degraded.

It is therefore an object of the present invention to provide a packet data scheduling method capable of maintaining both QoS and fairness for mobile stations (flows) and improving channel use efficiency.

### MEANS FOR SOLVING THE PROBLEM

A scheduling method of the present invention is a packet data scheduling method used in a radio communication apparatus transmitting packet data to a plurality of communicating parties using a plurality of subchannels, the method comprising: a first step of setting a total transmission rate for the plurality of communicating parties; a second step of calculating a traffic amount for each of the plurality of communicating parties in accordance with the total transmission rate and a weighting factor assigned to each of the plurality of communicating parties; a third step of assigning the plurality of subchannels to the plurality of communicating parties in accordance with channel quality up to upper limits of the traffic amounts; a fourth step of calculating a transmission rate for a subchannel that is not assigned to any of the plurality of communicating parties in the third step among the plurality of subchannels; and a fifth step of updating the total transmission rate using the transmission rate calculated in the fourth step, wherein the second step, the third step, the fourth step and the fifth step are performed repeatedly until the number of subchannels that are not assigned to any of the plurality of communicating parities in the third step is equal to or less than a threshold.

### ADVANTAGES EFFECT OF THE INVENTION

According to the scheduling method of the present invention, it is possible to maintain both QoS and fairness for mobile stations (flows) and improve channel use efficiency.

### BRIEF DESCRIPTION OF DRAWINGS

FIG. 1 is a view showing CQI's of mobile stations;

FIG. 2 is another view showing CQI's of mobile stations;

FIG. 3 is a flowchart of a scheduling method according to an embodiment of the present invention;

FIG. 4 is a graph showing a relationship between reception SINR and PER according to an embodiment of the present invention;

FIG. 5 is an example of CQI's of mobile stations and subcarriers according to an embodiment of the present invention;

FIG. 6 is a view showing relationships between CQI's, modulation schemes, and the numbers of bits transmitted per symbol according to an embodiment of the present invention;

FIG. 7 is a view showing subcarrier assignment according to an embodiment of the present invention;

FIG. 8 is another view showing subcarrier assignment according to an embodiment of the present invention;

FIG. 9 is another view showing subcarrier assignment according to an embodiment of the present invention; and

FIG. 10 is a block diagram showing a configuration of a radio transmission apparatus according to an embodiment of the present invention.

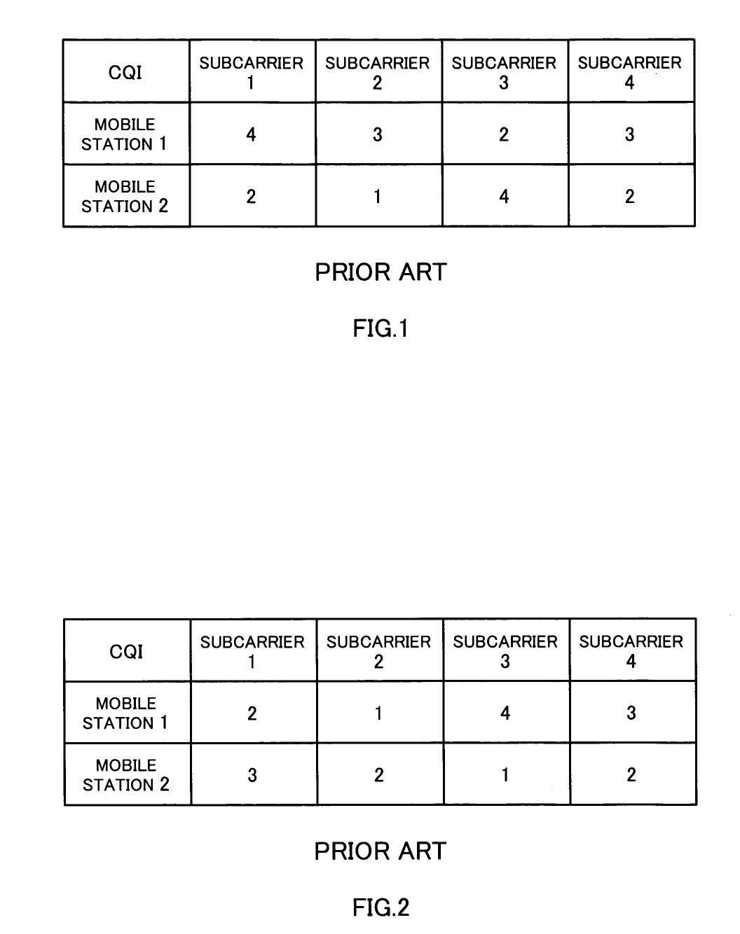

### BEST MODE FOR CARRYING OUT THE INVENTION

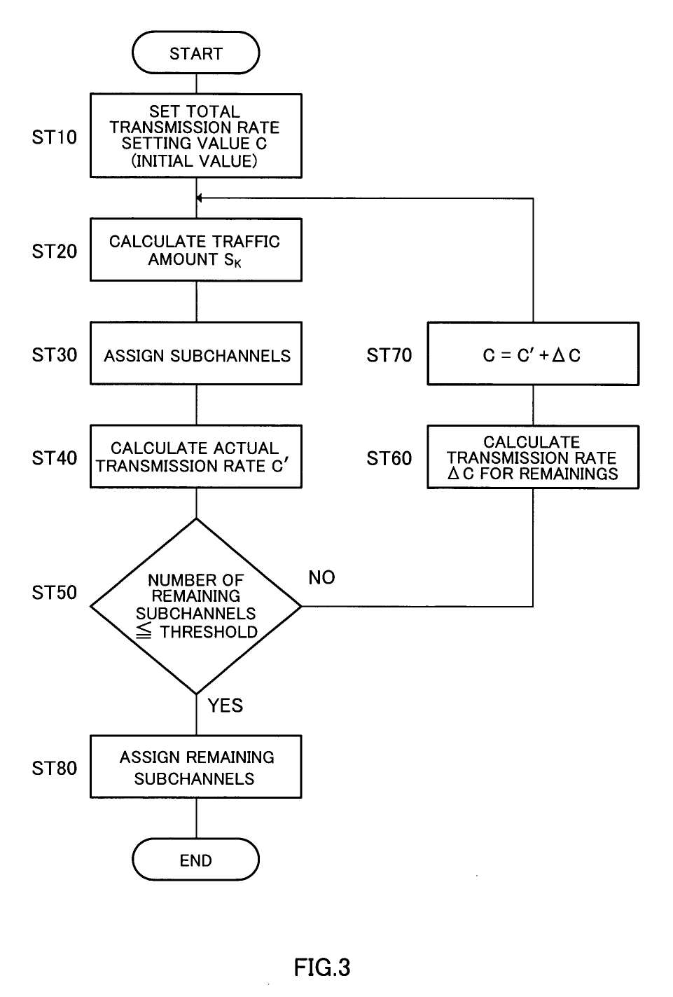

FIG. 3 is a flowchart of a scheduling method according to an embodiment of the present invention. A description will be given below with reference to this flowchart.

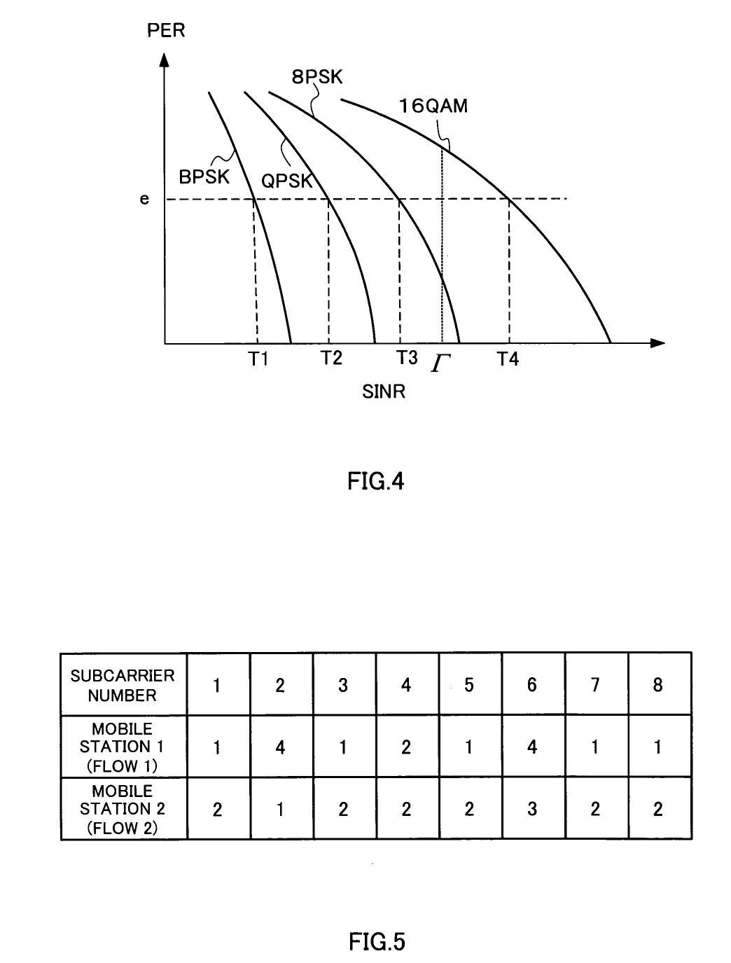

First, in ST (step) 10, a total transmission rate setting value C (initial value) is set according to equation (1).

[Equation 1]
C=βC^{M}, 0<β<1 (1)
where CM is the transmission rate when subchannel assignment is performed using the Max-C/I method, and can be expressed by equation (2).

$$\begin{matrix}[ Equation 2 ] & \\ {C}^{M} = {\sum }_{n = 1}^{N} {\sum }_{k ∈ B} {α}_{k , n } F ( {Γ}_{k , n} , {e}_{k} ) , where & ( 2 ) \\ {α}_{k , n} = \{ \begin{matrix}1 , & if k = {k}^{*} = {arg max}_{k ∈ B} ( {Γ}_{k , n} ) \\ 0 , & otherwise\end{matrix} for n = 1 , 2 , … , N & \end{matrix}$$

where F(Γ_{f,n},eₖ) expresses a transmission rate at which a mobile station can satisfy PER (Packet Error Rate)=eₖ at reception SINR=Γ_{k,n}. Also, B shows a set of mobile stations (flows) for which packets are stored in that slot period. Further, the value of F(Γ_{k,n},eₖ) depends upon MCS (Modulation Coding Scheme). That is, when adaptive modulation is performed on subchannels, the most efficient modulation scheme is selected so as to satisfy PER=e for reception SINR=Γ. When reception SINR=Γ and PER=e are as shown in FIG. 4, 8PSK is selected as a modulation scheme. Here, a function f(Γ,e) is expressed by the number of bits corresponding to the selected modulation scheme. One bit, two bits, three bits, and four bits can be transmitted per symbol in BPSK, QPSK, 8PSK, 16QAM, respectively. Therefore, when 8PSK is selected as a modulation scheme, it follows that f(Γ,e) =3 bits. Now, if 100 symbols are transmitted per subcarrier in one second, it follows that F(Γ,e)=100×f(Γ,e)=300 bits/s.

Next, in ST20, traffic amount Sₖ for each of the mobile stations (flows) is calculated according to equation (3) using the GPS method.

$$\begin{matrix}[ Equation 3 ] & \\ {S}_{k} = \{ \begin{matrix}\frac{{ϕ}_{k}}{{\sum }_{k ∈ B} {ϕ}_{k}} CT , & if {η}_{k} > 0 \\ 0 , & otherwise\end{matrix} & ( 3 )\end{matrix}$$

where φₖ is the weighting factor assigned to the mobile station (flow), C is the total transmission rate estimation value set in ST10, and T is the length of a time slot. Further, ηₖ is the traffic amount for mobile station k (flow k) in one slot period. φₖ is given by equation (4). In equation (4), Rₖ is a required transmission rate of mobile station k (flow k).

$$\begin{matrix}[ Equation 4 ] & \\ {ϕ}_{k} = \frac{{R}_{k}}{{\sum }_{k = 1}^{K} {R}_{k}} & ( 4 )\end{matrix}$$

Next, in ST30, packets for mobile stations (flows) are assigned to the subchannels. This subchannel assignment is performed by the Max-C/I method.

Next, in ST40, the actual transmission rate (effective transmission rate) C′ is calculated according to equation (5). Here, rₖ represents the actual transmission rate for a mobile station (flow).

$$\begin{matrix}[ Equation 5 ] & \\ {C}^{′} = {\sum }_{k ∈ B} {r}_{k} & ( 5 )\end{matrix}$$

Next, in ST50, whether or not the number of remaining subchannels to which packets are not assigned in ST30, is equal to or less than a threshold is determined. Then, when the number of remaining subchannels is not equal to or less than the threshold (“NO” in ST50), the transmission rate ΔC for these remaining subchannels is calculated in ST60, and C is reset to C′+ΔC in ST 70. In other words, C is updated using ΔC. Thereafter, the processing returns to ST20 and the processing of ST20 through ST70 is repeated until the number of remaining subchannels is equal to or less than the threshold in ST50.

Then, when the number of remaining subchannels is determined to be equal to or less than the threshold in ST50 (“YES” in ST50), assignment of the remaining subchannels is performed in ST80.

Next, more specifically, the scheduling method of the flowchart shown in FIG. 3 will be described. In the description below, OFDM will be described as an example. Accordingly, a subcarrier is equivalent to a subchannel. Also, assume that the number of mobile stations (the number of flows) is K=2 and the number of subcarriers is N =8. Further, assume that the length of a time slot is T=1 sec, and 100 symbols are transmitted in one second. Still further, assume that the threshold for the number of remaining subcarriers is ε=1. Also, if the required transmission rate for mobile station 1 (flow 1) is R₁=1200 bits/s and the required transmission rate for mobile station 2 (flow 2) is R₂=400 bits/s, the weighting factor φ₁ for mobile station 1 and the weighting factor φ₂ for mobile station 2 are as shown in equation (6).

$$\begin{matrix}[ Equation 6 ] & \\ \begin{matrix}{ϕ}_{1} = \frac{{R}_{1}}{{R}_{1} + {R}_{2}} = \frac{3}{4} , & {ϕ}_{2} = \frac{{R}_{2}}{{R}_{1} + {R}_{2}} = \frac{1}{4}\end{matrix} & ( 6 )\end{matrix}$$

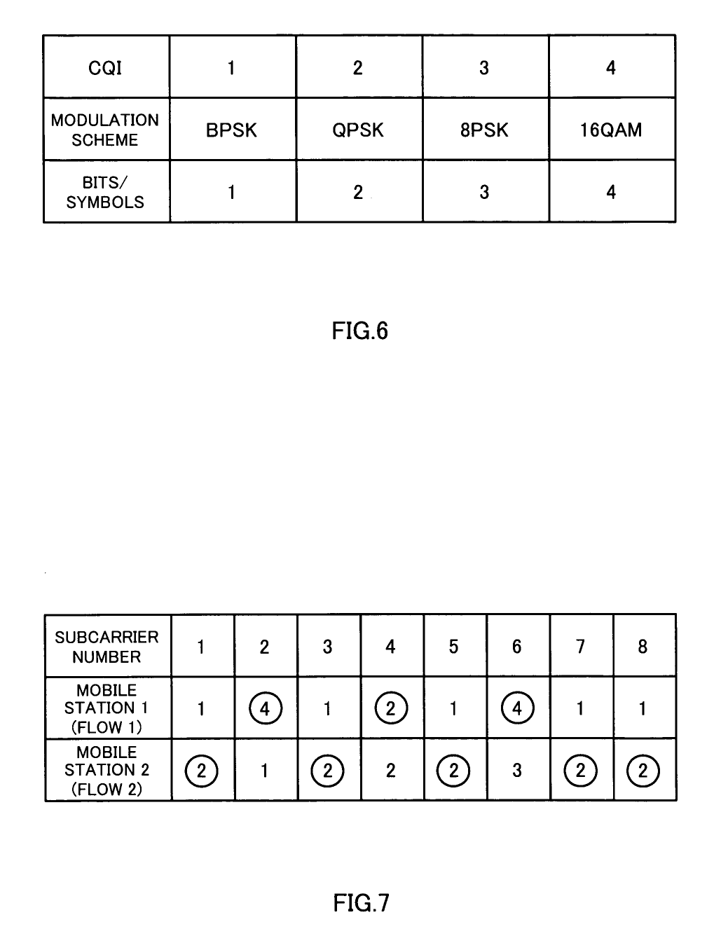

Now, assume that the CQI's of mobile stations and subcarriers are as shown in FIG. 5. The relationships between CQI's, modulation schemes, and the numbers of bits are as shown in FIG. 6.

First, in ST10, a total transmission rate setting value C (initial value) is set for mobile station 1 and mobile station 2. Accordingly, subcarrier assignment is performed according to the Max-C/I method. As a result, subcarriers 2, 4 and 6 are assigned to mobile station 1, and subcarriers 1, 3, 5, 7 and 8 are assigned to mobile station 2 (FIG. 7). Accordingly, CM in above equation (1) is as shown in equation (7).

[Equation 7]
C^{M}=(2+4+2+2+2+4+2+2)×100 bits/s=2000 bits/s (7)

Here, if β=0.6, the total transmission rate setting value C (initial value) eventually becomes as shown in equation (8).

[Equation 8]
C=β·C^{M}=0.6×2000=1200 bits/s (8)

Next, in ST 20, traffic amounts S₁ and S₂ for the mobile stations (flows) are calculated using C=1200 bits/s set in ST10 according to above equation (3). As a result, traffic amounts S₁ and S₂ are as shown in equation (9).

$$\begin{matrix}[ Equation 9 ] & \\ \begin{matrix}{S}_{1} = \frac{{ϕ}_{1}}{{ϕ}_{1} + {ϕ}_{2}} CT = 900 bits , & {S}_{2} = \frac{{ϕ}_{2}}{{ϕ}_{1} + {ϕ}_{2}} CT = 300 bits\end{matrix} & ( 9 )\end{matrix}$$

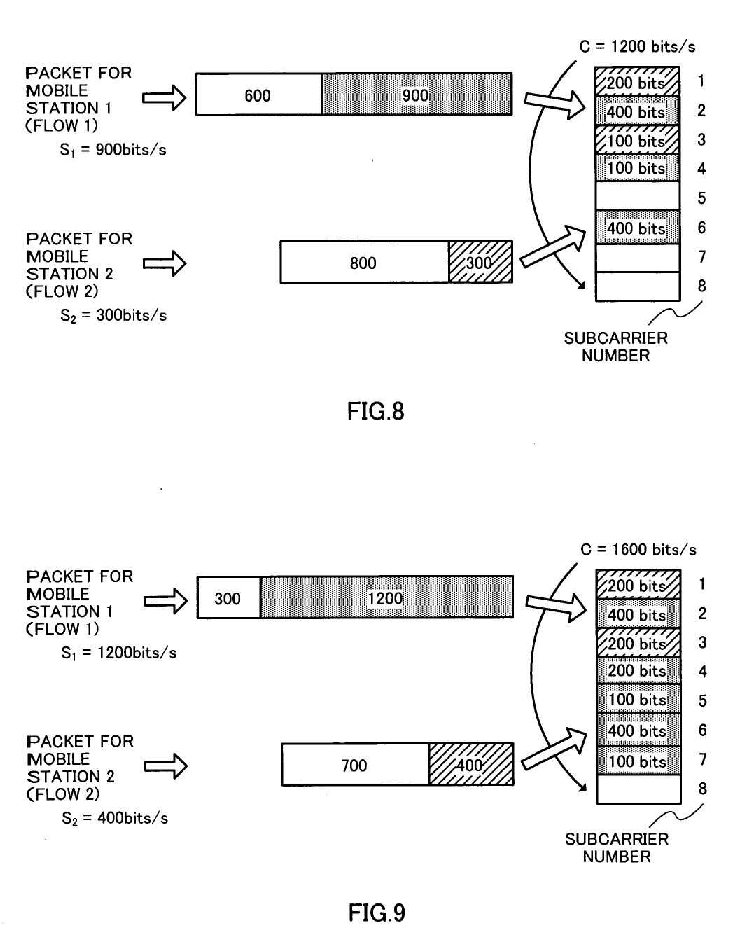

Next, in ST30, packets for the mobile stations (flows) are assigned to subcarriers up to upper limits of traffic amounts S₁ and S₂ by the Max-C/I method. As a result, subcarrier assignment is as shown in FIG. 8.

Next, in ST40, the effective transmission rate C′ is calculated from the result of assignment in ST30. Here, the effective transmission rate C′ is as shown in equation (10).

[Equation 10]
C′=900+300=1200 bits/s (10)

Next, in ST50, whether or not the number of remaining subcarriers is equal to or less than a threshold is determined. According to FIG. 8, the number of remaining subcarriers Nᵤ, to which packets are not assigned, is “3” and the threshold ε is “1.” Accordingly, “NO” is determined in ST50, and the processing proceeds to ST60.

In ST60, transmission rate ΔC for the remaining subcarriers 5, 7 and 8 to which the packets are not assigned in ST30, is calculated. In above FIG. 7, subcarriers 5, 7 and 8 are assigned to mobile station 2 and all have CQI of “2,” so that the transmission rate ΔC is as shown in equation (11).

[Equation 11]
ΔC=β·(2+2+2)×100=0.6×600=360 bits/s (11)

Then, in ST70, C is reset to C′+ΔC. As a result, C is reset as shown in equation (12). The processing again returns to ST20.

[Equation 12]
C=C+ΔC=1200+360=1560≈1600 bits/s (12)

Next, in ST20, traffic amounts S₁ and S₂ for the mobile stations (flows) are calculated again using C=1600 bits/s reset in ST70 according to above equation (3). As a result, traffic amounts S₁ and S₂ are as shown in equation (13).

$$\begin{matrix}[ Equation 13 ] & \\ \begin{matrix}{S}_{1} = \frac{{ϕ}_{1}}{{ϕ}_{1} + {ϕ}_{2}} CT = 1200 bits , & {S}_{2} = \frac{{ϕ}_{2}}{{ϕ}_{1} + {ϕ}_{2}} CT = 400 bits\end{matrix} & ( 13 )\end{matrix}$$

Next, in ST30, packets for the mobile stations (flows) are assigned to the subcarriers up to upper limits of traffic amounts S₁ and S₂ by the Max-C/I method. As a result, the subcarrier assignment is as shown in FIG. 9. That is, packets for mobile station 2 are assigned to subcarriers 5 and 7.

Next, in ST40, the effective transmission rate C′ is calculated according to the result of assignment in ST30. Here, the effective transmission rate C′ is as shown in equation (14).

[Equation 14]
C′=1200+(200+200)=1600 bits/s (14)

Next, in ST50, whether or not the number of remaining subcarriers is equal to or less than a threshold is determined. According to FIG. 9, the number of remaining subcarriers Nᵤ, to which packets are not assigned, is now “1” and the threshold ε is “1.” Accordingly, “YES” is determined in ST50, and the processing proceeds to ST60. Then, in ST80, the remaining subcarrier 8 is assigned to mobile station 2.

Although the total transmission rate setting value C (initial value) is set according to equation (1) in this embodiment, C may also be set as below. For example, C for slot i may be set at the transmission rate of the packet correctly received in the previous slot (i-1). Further, setting according to equation (15) or equation (16) below is also possible. Moreover, in CDMA scheme communication, setting according to equation (17) below is also possible. In equation (17), gₖ is the number of codes assigned to mobile station k (flow k), aₖ is aₖ=1/SINRₖ, and G is the maximum number of multiplex codes. The setting methods described here can be used when the transmission rate ΔC for remaining subcarriers to which packets are not assigned is calculated in the above-mentioned ST60.

$$\begin{matrix}[ Equation 15 ] & \\ \begin{matrix}C = γ {\sum }_{k ∈ B} {g}_{k} {R}_{k}^{t} , & ( γ \geq 1 )\end{matrix} & ( 15 ) \\ \begin{matrix}where & {g}_{k} = \frac{{ϕ}_{k}}{{\sum }_{k ∈ B} {ϕ}_{k}} , & {R}_{k}^{t} = {\sum }_{n = 1}^{N} F ( {Γ}_{k , n} , {e}_{k} )\end{matrix} & \\ [ Equation 16 ] & \\ C = μ {\sum }_{k ∈ B} {g}_{k} {R}_{k}^{a} & ( 16 ) \\ \begin{matrix}where & {R}_{k}^{a} = {\sum }_{n ∈ {A}_{k}} F ( {Γ}_{k , n} , {e}_{k} )\end{matrix} & \\ [ Equation 17 ] & \\ C = {\sum }_{k ∈ B} {g}_{k} F ( {Γ}_{k} , {e}_{k} ) & ( 17 ) \\ \begin{matrix}where & {g}_{k} = \frac{{a}_{k} {ϕ}_{k}}{{\sum }_{k ∈ B} {a}_{k} {ϕ}_{k}} G\end{matrix} & \end{matrix}$$

Further, it is also possible to simplify the scheduling processing by assuming the processing in ST70 as “C=C+ΔC” and omitting the processing in ST40 in the flowchart of above FIG. 3.

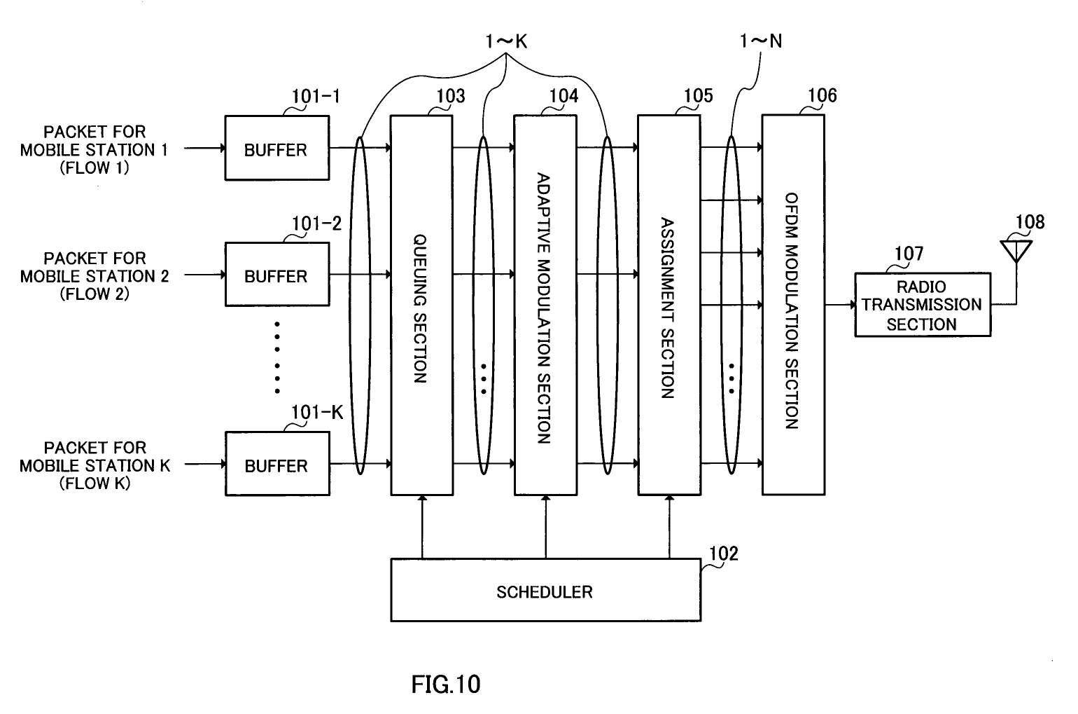

A radio transmission apparatus that performs the above scheduling method will now be described. FIG. 10 is a block diagram showing a radio transmission apparatus according to an embodiment of the present invention. In FIG. 10, buffers 101-1 to 101-K buffer packets for mobile stations 1 to K, respectively. Scheduler 102 performs scheduling according to the flowchart in the above FIG. 3. Under control by scheduler 102, queuing section 103 inputs the packets buffered in buffers 101-1 to K to adaptive modulation section 104 in accordance with traffic amount Sₖ. Adaptive modulation section 104 modulates the input packets by the modulation scheme designated by scheduler 102. The modulation scheme in scheduler 102 is determined in accordance with CQI. Under control by scheduler 102, assignment section 105 assigns the packets for mobile stations 1 to K to subcarriers 1 to N as described above. OFDM modulation section 106 then performs inverse fast Fourier transform (IFFT) on subcarriers 1 to N, and generates OFDM signals. The OFDM signals are subjected to predetermined radio processing in radio transmission section 107, and then transmitted to mobile stations 1 to K from antenna 108.

Although the radio transmission apparatus of the OFDM scheme has been described here, it is also possible to implement the scheduling method of this embodiment with a radio transmission apparatus of the CDMA scheme. In this case, a subchannel in the above scheduling method is equivalent to a spreading code that is subjected to multicode-multiplex.

Thus, according to this embodiment, the total transmission rate setting value in the GPS method is found from the result of the subchannel assignment by Max-C/I method, so that the total transmission setting value is nearly identical to the actual transmission rate. As a result, it is possible to perform subchannel assignment where fairness between mobile stations is maintained. Further, by repeating the GPS method considering fairness and the Max-C/I method considering channel use efficiency according to the above-mentioned flowchart of FIG. 3, it is possible to maintain fairness between mobile stations and improve channel use efficiency.

In addition, each of functional blocks employed in the description of the above-mentioned embodiment may typically be implemented as an LSI constituted by an integrated circuit. These are may be individual chips or partially or totally contained on a single chip.

“LSI” is adopted here but this may also be referred to as an “IC”, “system LSI”, “super LSI”, or “ultra LSI” depending on differing extents of integration.

Further, the method of integrating circuits is not limited to the LSI's, and implementation using dedicated circuitry or general purpose processor is also possible. After LSI manufacture, utilization of FPGA (Field Programmable Gate Array) or a reconfigurable processor where connections or settings of circuit cells within an LSI can be reconfigured is also possible.

Furthermore, if integrated circuit technology comes out to replace LSI's as a result of the advancement of semiconductor technology or derivative other technology, it is naturally also possible to carry out function block integration using this technology. Application in biotechnology is also possible.

The present application is based on Japanese Patent Application No.2004-082891, filed on Mar. 22, 2004, the entire content of which is expressly incorporated by reference herein.

### INDUSTRIAL APPLICABILITY

The present invention is suitable for, for example, a base station apparatus used in a mobile communication system.

1. A packet data scheduling method used in a radio communication apparatus transmitting packet data to a plurality of communicating parties using a plurality of subchannels, the method comprising:
a first step of setting a total transmission rate for the plurality of communicating parties;
a second step of calculating a traffic amount for each of the plurality of communicating parties in accordance with the total transmission rate and a weighting factor assigned to each of the plurality of communicating parties;
a third step of assigning the plurality of subchannels to the plurality of communicating parties in accordance with channel quality up to upper limits of the traffic amounts;
a fourth step of calculating a transmission rate for a subchannel that is not assigned to any of the plurality of communicating parties in the third step among the plurality of subchannels; and
a fifth step of updating the total transmission rate using the transmission rate calculated in the fourth step,
wherein the second step, the third step, the fourth step and the fifth step are performed repeatedly until the number of subchannels that are not assigned to any of the plurality of communicating parities in the third step is equal to or less than a threshold.

2. A radio communication apparatus that transmits packet data to a plurality of communicating parties using a plurality of subchannels, the apparatus comprising:
a scheduler that performs scheduling for the packet data, the scheduling comprising:
a first step of setting a total transmission rate for the plurality of communicating parties;
a second step of calculating a traffic amount for each of the plurality of communicating parties in accordance with the total transmission rate and a weighting factor assigned to each of the plurality of communicating parties;
a third step of assigning the plurality of subchannels to the plurality of communicating parties in accordance with channel quality up to upper limits of the traffic amounts;
a fourth step of calculating a transmission rate for a subchannel that is not assigned to any of the plurality of communicating parties in the third step among the plurality of subchannels; and
a fifth step of updating the total transmission rate using the transmission rate calculated in the fourth step; and
an assignment section that assigns the packet data to the plurality of subchannels according to the scheduling,
wherein the scheduler performs the second step, the third step, the fourth step and the fifth step repeatedly until the number of subchannels that are not assigned to any of the plurality of communicating parities in the third step is equal to or less than a threshold.
